(19) United States
(12) Patent Application Publication
(10) Pub. No.: US 2020/0112015 A1
(43) Pub. Date: Apr. 9, 2020

(54) METHOD AND APPARATUS FOR LASER WELDING

(71) Applicant: GM Global Technology Operations LLC, Detroit, MI (US)

(72) Inventors: Wu Tao, Tianmen (CN); Teresa J. Rinker, Royal Oak, MI (US)

(73) Assignee: GM Global Technology Operations LLC, Detroit, MI (US)

(21) Appl. No.: 16/151,953

(22) Filed: Oct. 4, 2018

(51) Int. Cl. H01M 2/26; B23K 26/22

(52) U.S. Cl. CPC H01M 2/266; B23K 26/22

(57) ABSTRACT

A laser welder and associated method for joining battery cell foils to a battery tab is described. The joining method includes arranging the plurality of battery cell foils in a stack, wherein the first edges of the battery cell foils are disposed in parallel. The battery cell foils arranged in the stack are positioned such that the first edges of the battery cell foils underlap with the battery tab. A compressive load may be applied to the plurality of battery cell foils and the battery tab. The laser welder executes welding operation to form a weld joint that mechanically and electrically joins the battery cell foils and the battery tab. The welding operation includes the laser welder applying a laser beam to the second surface of the battery tab. The welding operation is executed near first edges of the battery cell foils.

### INTRODUCTION

Laser welding is a metal joining process in which a laser beam is directed at a stack of metal workpieces to provide a concentrated energy source capable of generating a fusion weld joint between the overlapping constituent metal workpieces. Layers of metal workpieces may be stacked and aligned relative to one another such that their faying surfaces overlap to establish a faying interface (or faying interfaces) within an intended weld site. A laser beam is then directed at or near a top surface of the workpiece stack. The heat generated from the absorption of energy that is supplied by the laser beam initiates melting of the metal workpieces and establishes a molten weld pool within the workpiece stack. The molten weld pool penetrates through the metal workpiece impinged upon by the laser beam and into the underlying metal workpiece or workpieces to a depth that intersects with all of the established faying interfaces.

The laser beam rapidly generates a molten weld pool upon impinging the top surface of the workpiece stack. After the molten weld pool is formed and stable, the laser beam is advanced along the top surface of the workpiece stack while tracking a predetermined weld path. Such advancement of the laser beam translates the molten weld pool along a corresponding course relative to the top surface of the workpiece stack and leaves behind molten workpiece material in the wake of the advancing weld pool that includes material from the layers of the metal workpieces in the workpiece stack. This penetrating molten workpiece material cools and solidifies to form a weld joint that is composed of re-solidified materials from all the layers of the metal workpieces. Such fusion of the material from the overlapping layers of the metal workpieces forms a weld joint.

The heat from laser welding has been known to act upon layers of workpieces to distort the workpieces and generate localized material voids between the workpieces as a result of heat and vapor. Localized material voids, which may be manifested as gaps between layers in the workpiece stack and/or as voids in one or more of the workpieces may affect service life of the weld joint, and hence affect service life of the component that includes the weld joint. When the workpiece stack includes a plurality of battery cell foils that are welded to a battery tab, the occurrence of localized material voids may affect electrical conductivity between one or more of the battery cell foils and the battery tab.

### SUMMARY

A device and associated method for joining, via a laser welder, a plurality of battery cell foils to a battery tab is described. Each of the battery cell foils is configured as a sheet including an edge, and is electrically connected to an anode or a cathode of a battery cell. The battery tab is configured as a sheet including an edge, a first surface, and a second surface that is opposed to the first surface. The joining method includes arranging the plurality of battery cell foils in a stack, wherein the first edges of the battery cell foils are disposed in parallel. The battery cell foils arranged in the stack are positioned such that the first edges of the battery cell foils underlap with the battery tab. A compressive load may be applied to the plurality of battery cell foils and the battery tab. The laser welder executes welding operation to form a weld joint that mechanically and electrically joins the battery cell foils and the battery tab. The welding operation includes the laser welder applying a laser beam to the second surface of the battery tab. The welding operation is executed near the first edges of the battery cell foils, and a weld joint is formed within 1.5 mm of the first edges of the battery cell foils.

An aspect of the disclosure includes the first edges of the battery cell foils being arranged in parallel and defining a second plane that is orthogonal to a first plane that is defined by the stacked battery cell foils.

Another aspect of the disclosure includes the first edges of the battery cell foils being arranged in parallel and defining a second plane that is tapered relative to a first plane that is defined by the stacked battery cell foils.

Another aspect of the disclosure includes the plurality of cell foils including a bottom cell foil that is disposed most distant from the battery tab, and wherein the welding operation is executed within 1.5 mm of the first edge of the bottom cell foil.

Another aspect of the disclosure includes applying the compressive load to the plurality of battery cell foils and the battery tab but excluding a portion of the battery cell foils that underlaps the portion of the battery tab.

Another aspect of the disclosure includes an apparatus for joining a plurality of battery cell foils to a battery tab, wherein each of the battery cell foils is configured as a sheet including a first edge, and wherein the battery tab is configured as a sheet including a second edge. The apparatus includes a laser welder and a clamping mechanism including an anvil, a first clamping device and a second clamping device. The laser welder is operable to execute a welding operation to form a weld that joins the battery cell foils and the battery tab, including directing a laser beam onto the second surface of the battery tab, wherein the weld is formed within 1.5 mm of the first edges of the battery cell foils.

Another aspect of the disclosure includes a weld joint that includes a plurality of battery cell foils, wherein each of the battery cell foils is configured as a sheet including a first edge, and a battery tab, wherein the battery tab is configured as a sheet including a first surface, and a second surface that is opposed to the first surface, and a second edge. The battery cell foils are arranged in a stack with the first edges of the battery cell foils being disposed in parallel, and the battery cell foils being arranged in the stack such that the first edges of the battery cell foils underlap a portion of the battery tab. The battery cell foils are joined to the battery tab by applying a compressive load to the plurality of battery cell foils and the battery tab and executing, via the laser welder, a welding operation to form a weld joint joining the battery cell foils and the battery tab. The welding operation includes directing a laser beam onto the second surface of the battery tab, wherein the weld joint is formed within 1.5 mm of the first edges of the battery cell foils.

Another aspect of the disclosure includes the battery tab being fabricated from either copper or aluminum.

Another aspect of the disclosure includes the battery cell foils being fabricated from either copper or aluminum.

Another aspect of the disclosure includes each of the battery cell foils having a thickness of 0.02 mm.

Another aspect of the disclosure includes the weld joint being a butt joint.

Another aspect of the disclosure includes the weld joint being a fillet joint.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

One or more embodiments will now be described, by way of example, with reference to the accompanying drawings, in which:

FIG. 1 schematically shows a side-view of an arrangement for welding a workpiece stack that includes a battery tab element and a plurality of stacked battery cell foil elements, in accordance with the disclosure;

FIG. 2 schematically shows an isometric view of an arrangement for welding a workpiece stack that includes a battery tab element and a plurality of stacked battery cell foil elements to achieve a butt joint, in accordance with the disclosure;

FIG. 3 pictorially shows a side-view of a resultant butt joint that includes a battery tab element welded to a plurality of stacked battery cell foil elements, in accordance with the disclosure; and

FIG. 4 schematically shows a side-view of an arrangement for welding a first tab element to a plurality of stacked second tab elements to achieve a fillet joint, in accordance with the disclosure;

FIG. 5 pictorially shows a side-view of a resultant fillet joint that includes a battery tab element welded to a plurality of stacked battery cell foil elements, in accordance with the disclosure

FIG. 6 schematically shows a side-view of an arrangement for welding a first tab element to a plurality of stacked second tab elements to achieve a tapered fillet joint, in accordance with the disclosure;

The appended drawings are not necessarily to scale, and present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some of these details. Moreover, for the purpose of clarity, certain technical material that is understood in the related art has not been described in detail in order to avoid unnecessarily obscuring the disclosure. Furthermore, the drawings are in simplified form and are not to precise scale. For purposes of convenience and clarity only, directional terms such as top, bottom, left, right, up, over, above, below, beneath, rear, and front, may be employed to assist in describing the drawings. These and similar directional terms are illustrative, and are not to be construed to limit the scope of the disclosure. Furthermore, the disclosure, as illustrated and described herein, may be practiced in the absence of an element that is not specifically disclosed herein.

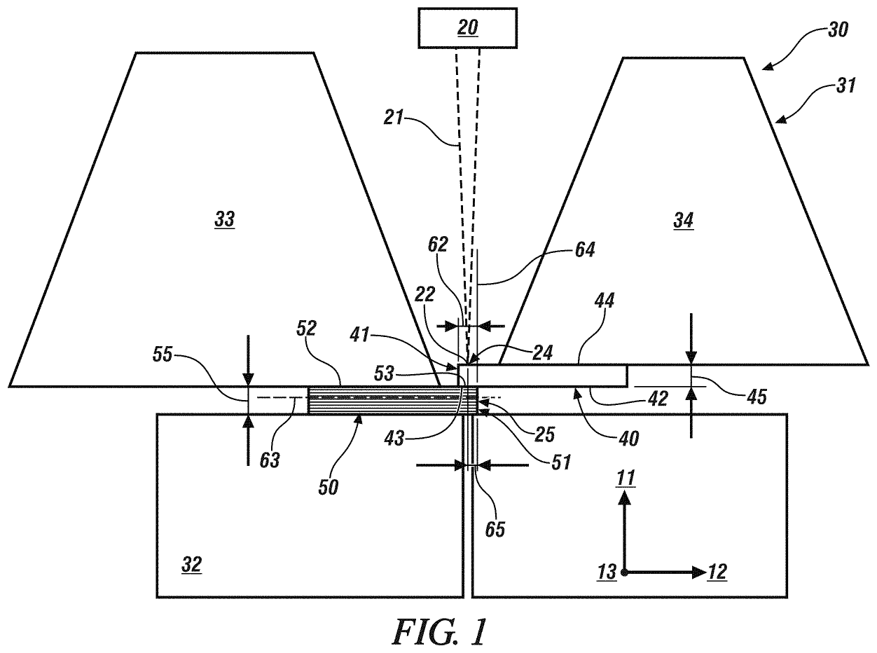

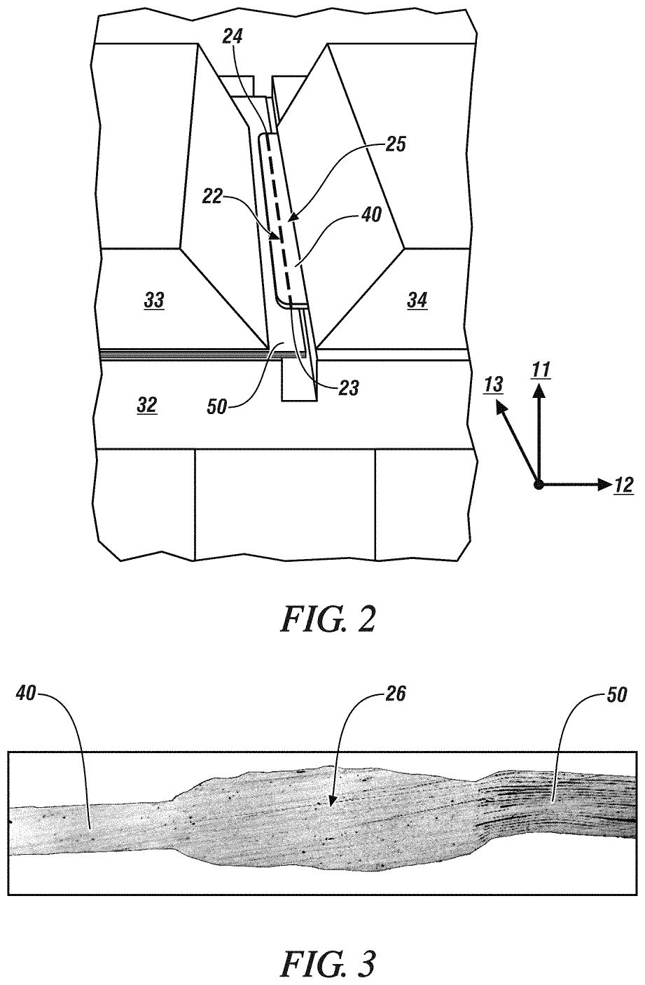

Referring to the drawings, wherein like reference numerals correspond to like or similar components throughout the several Figures, FIGS. 1, 2 and 3, consistent with embodiments disclosed herein, schematically illustrate an embodiment of a laser welder 20 and associated welding system 30 that are configured to act on a workpiece stack 25 along a weld path 22 to generate a weld joint 26. In this embodiment, a resultant weld joint 26 is a butt joint since the ends of the elements of the workpiece stack 25 terminate at the weld joint 26. The laser welder 20 and associated welding system 30 are shown in context of a horizontal axis 12, a vertical axis 11, and a third axis 13 that projects orthogonal thereto. Like numerals refer to like elements throughout the various drawings.

In one embodiment, and as described herein, the workpiece stack 25 includes a plurality of battery cell foils 50 and a battery tab 40 that are arranged in a stacked configuration, wherein the laser welder 20 may be operated to effect welding thereof. Welding includes mechanically and electrically joining the plurality of battery cell foils 50 to the battery tab 40, via a fusion process.

The battery cell foils 50 are portions of electrodes of individual battery cells (not shown) that serve as anodes or cathodes for a respective battery cell. The battery cell foils 50 may be wholly or partly fabricated from copper, nickel, or nickel-coated copper in one embodiment, for example when configured as a cathode. The battery cell foils 50 may be wholly or partly fabricated from aluminum in one embodiment, for example when configured as an anode. In one embodiment, each of the battery cell foils 50 has a thickness that is between 0.005 millimeters and 0.02 millimeters, and the stacked battery cell foils 50 have a total predefined thickness 55. Each of the battery cell foils 50 is configured as a planar sheet that includes an edge 51, a first, top surface 52, and a second, bottom surface 53. Each of the battery cell foils 50 includes a portion referred to as a faying surface, i.e., a surface portion that is part of the weld path 22. The one of the battery cell foils 50 that is adjacent to the battery tab 40 during welding includes a faying surface portion that is in contact with a corresponding faying surface portion 43 of the battery tab 40 when the workpiece stack 25 is formed.

The battery tab 40 is configured as a planar sheet including an edge 41, a first, bottom surface 42 including a faying surface portion 43, and a second, top surface 44 that is opposite to the first surface 42. The battery tab 40 may be wholly or partly fabricated from copper or aluminum in one embodiment. In one embodiment, battery tab 40 has a thickness of 0.2 mm, and is fabricated from nickel-coated copper. The battery tab 40 may also have other features that are relevant to its mechanical, electrical and packaging functions within a battery assembly. During battery manufacturing and assembly, it useful to mechanically and electrically join the battery tab 40 to the plurality of battery cell foils 50 to effect current transfer.

The workpiece stack 25 includes a stack that is composed of the battery tab 40 and a plurality of the battery cell foils 50, such as in a manner shown with reference to FIG. 1. In one embodiment, there are twenty of the battery cell foils 50 arranged in the workpiece stack 25. In this embodiment, the first edges 51 of the battery cell foils 50 are disposed in parallel and are arranged to abut a second plane 64 that is orthogonal to a first plane 63 that is defined by the plurality of stacked battery cell foils 50. Furthermore, the workpiece stack 25 includes the battery tab 40 being arranged in relation to the plurality of the battery cell foils 50 such that the battery tab 40 is positioned overtop of the plurality of battery cell foils 50 at a predefined overlap 62.

The laser welder 20 and associated welding system 30 act upon the workpiece stack 25 to advantageously mechanically and electrically join the battery cell foils 50 to the battery tab 40 via fusion. The laser welder 20 is a solid-state device that generates, focuses and directs a laser beam 21, including being advantageously disposed to direct the laser beam 21 at the top surface 44 of the battery tab 40 when the workpiece stack 25 is secured in the welding system 30. In one embodiment, the laser welder 20 may include a scanning optic laser head that is mounted to a robotic arm (not shown) to quickly and accurately carry the laser welder 20 to a preselected weld site on the workpiece stack 25 to form a weld joint 26 in response to programmed inputs. The laser beam 21 is a solid-state laser beam and, in particular, a fiber laser beam or a disk laser beam operating with a wavelength in the near-infrared range (commonly considered to be 700 nm to 1400 nm) of the electromagnetic spectrum. In one embodiment, the laser beam may be an optical fiber doped with rare-earth elements (e.g., erbium, ytterbium, neodymium, dysprosium, praseodymium, thulium, etc.) or a semiconductor associated with a fiber resonator. Alternatively, a disk laser beam may be employed, which includes a laser beam in which the gain medium is a thin disk of ytterbium-doped yttrium-aluminum garnet crystal that is coated with a reflective surface and mounted to a heat sink. The laser beam 21 impinges on the top surface 44 of the first workpiece 40 of the workpiece stack 25 and imparts localized heat to effect fusion welding. In one embodiment, the laser beam 21 may be controlled to a defocusing distance or focal point of −1.5 mm, i.e., a defocusing distance that is 1.5 mm below the top surface 44 of the first workpiece 40, with an attendant beam spot diameter of 0.6 mm. The example laser power levels and duty cycles stated herein may be selected specifically for use with copper, and may be adjusted based upon physical properties of the selected materials for the workpieces to be welded by the laser welder 20.

The welding system 30 includes a clamping mechanism 31 that is composed of an anvil 32, a first clamp 33 and a second clamp 34 that are advantageously arranged to apply compressive forces to the battery tab 40 and the plurality of the battery cell foils 50 to mechanically clamp and thus hold the workpiece stack 25 in position to effect fusion welding with the laser welder 20. The first and second clamps 33, 34 may be separate elements or, alternatively, a unitary element. The anvil 32 includes a cutout portion directly beneath the workpiece stack 25 along the weld path 22, which allows the laser beam 21 to pass therethrough while avoiding welding of the workpiece stack 25 to the anvil 32.

The welding process includes arranging the plurality of battery cell foils 50 in a stack, arranging the battery tab 40 overtop of the plurality of battery cell foils 50 at a predefined overlap 62 to form the workpiece stack 25, and clamping the elements of the workpiece stack 25 via the clamping mechanism 31. The laser welder 20 is employed to generate the laser beam 21 that is applied to the top of the workpiece stack 25 along the weld path 22 that is defined by linear travel between a first end 23 of the workpiece stack 25 and a second end 24 of the workpiece stack 25. The laser beam 21 is applied to the top surface 44 of battery tab 40 at the weld path 22, which is at a predefined distance 65 from the edge 51 of the plurality of battery cell foils 50, to form the weld joint 26. The predefined distance 65 of the weld path 22 from the edge 51 of the plurality of battery cell foils 50 is 1.5 mm in one embodiment. The laser welder 20 traverses a path to move the laser beam 21 along the weld path 22 between the first end 23 of the workpiece stack 25 and the second end 24 of the workpiece stack 25 to generate the weld joint 26. An example of a resultant weld joint 26 formed as a butt joint between the battery tab 40 and the plurality of stacked battery cell foils 50 is shown pictorially with reference to FIG. 3.

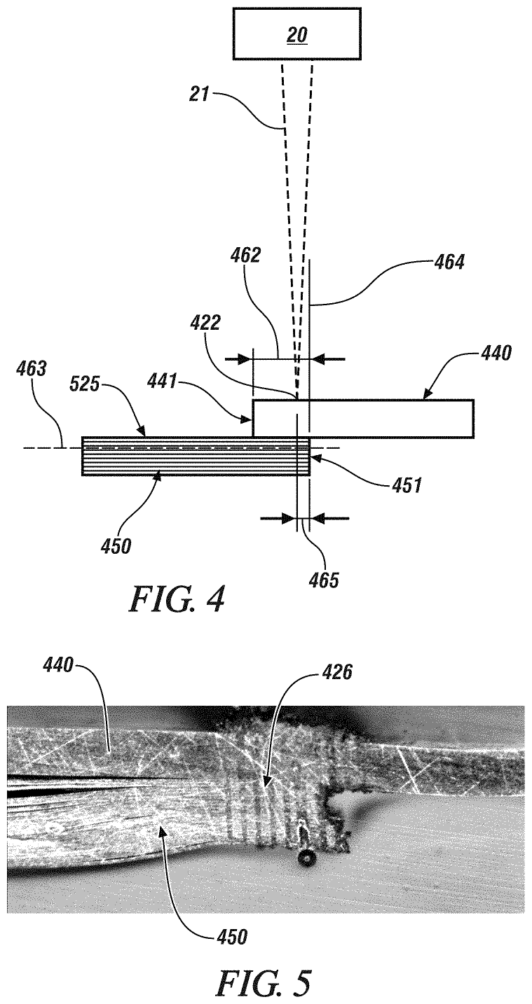

FIG. 4 schematically illustrates another embodiment of a workpiece stack 425 that may be advantageously joined by a laser welding process employing an embodiment of the laser welder 20 and associated welding system 30 that is described with reference to FIG. 1. The workpiece stack 425 includes a plurality of battery cell foils 450 that are disposed in a stack, with a battery tab 440 being disposed overtop of the plurality of battery cell foils 450 at a predefined overlap 462 to form the workpiece stack 425. Each of the battery cell foils 450 is configured as a planar sheet that includes an edge 451. In this embodiment, the edges 451 of the battery cell foils 450 are disposed in parallel and are arranged to abut a second plane 464 that is orthogonal to a first plane 463 that is defined by the plurality of stacked battery cell foils 450. Furthermore, the workpiece stack 425 includes the battery tab 440 being arranged in relation to the plurality of the battery cell foils 450 such that the battery tab 440 is positioned overtop of the plurality of battery cell foils 450 at a predefined overlap 462. The predefined overlap 462 is 4 mm in one embodiment. The workpiece stack 425 is configured as a lap joint between the battery tab 440 and the plurality of stacked battery cell foils 450, and the resultant weld joint 426 is a fillet joint after execution of the welding process since the end of the battery tab 440 extends beyond the ends of the plurality of stacked battery cell foils 450. The elements of the workpiece stack 425 are clamped via an embodiment of a clamping mechanism (not shown). The laser welder 20 is employed to generate the laser beam 21 that is applied to the top surface of the workpiece stack 425. The laser beam 21 is applied to the top surface of the battery tab 440 at a predefined distance 465 from an edge 451 of the plurality of battery cell foils 450 to a weld path 422 that is generated by the laser beam 21 of the laser welder 20. The predefined distance 465 from the weld joint 426 to the edge 451 of the plurality of battery cell foils 450 is 1.5 mm in one embodiment. An example of a resultant weld joint 426 formed as a fillet joint between the battery tab 440 and the plurality of stacked battery cell foils 450 is shown pictorially with reference to FIG. 5.

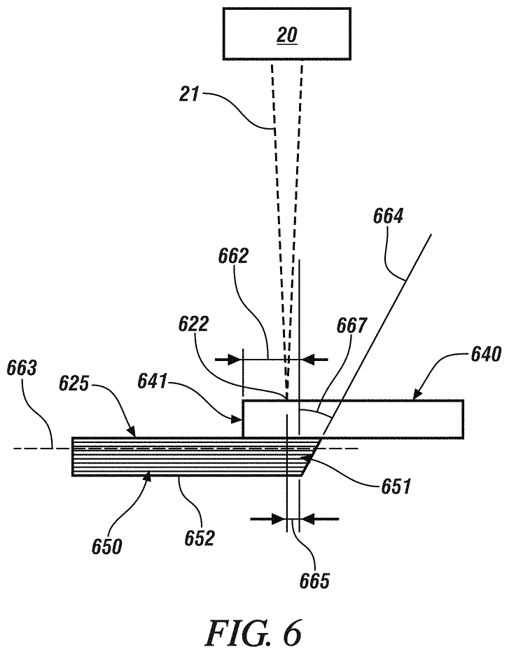

FIG. 6 schematically illustrates another embodiment of a workpiece stack 625 that may be advantageously joined by a laser welding process employing an embodiment of the laser welder 20 and associated welding system 30 that is described with reference to FIG. 1. The workpiece stack 625 includes a plurality of battery cell foils 650 that are disposed in a stack. A battery tab 640 is disposed overtop of the plurality of battery cell foils 650 at a predefined overlap 662 to form the workpiece stack 625. Each of the battery cell foils 650 is configured as a planar sheet that includes an edge 651. One of the battery cell foils 650 is indicated as a bottom cell foil 652 having an edge portion 653, wherein the bottom cell foil 652 is the one of the battery cell foils 650 that is disposed most distant from the battery tab 640.

In this embodiment, the edges 651 of the battery cell foils 650 are disposed in parallel in a tapered arrangement that forms a second plane 664 that is at an obtuse angle 667 to a first plane 663 that is defined by the plurality of stacked battery cell foils 650. The obtuse angle 667 between the first and second planes 663, 664 may be 135 degrees in one embodiment. Furthermore, the workpiece stack 625 includes the battery tab 640 being arranged in relation to the plurality of the battery cell foils 650 such that the battery tab 640 is positioned overtop of the plurality of battery cell foils 650 at the predefined overlap 662, which is 4 mm in one embodiment. The predefined overlap 662 is defined and measured from the edge portion 653 of the bottom cell foil 652.

The workpiece stack 625 is configured as a lap joint between the battery tab 640 and the plurality of stacked battery cell foils 650, and the resultant weld joint is a fillet joint after execution of the welding process since the end 641 of the battery tab 640 extends beyond the ends of the plurality of stacked battery cell foils 650. The elements of the workpiece stack 625 are clamped via an embodiment of a clamping mechanism (not shown). The laser welder 20 is employed to generate the laser beam 21 that is applied to the top surface of the workpiece stack 625 along a weld path 422. The laser beam 21 is applied to the top surface of the battery tab 640 at a predefined distance 665 from the edge portion 653 of the bottom cell foil 652 along the weld path 622 to form a weld joint 626. The predefined distance 665 from the weld path 622 to from the edge portion 653 of the bottom cell foil 652 is 1.5 mm in one embodiment. The tapered arrangement of the workpiece stack 625 may serve to reduce likelihood of misalignment of the stacked battery cell foils 650 and also reduce likelihood of porosity and formation of gaps between adjacent ones of the battery cell foils 650 in some embodiments.

Overall, localized material voids, which may be manifested as gaps between layers in a workpiece stack and/or as voids in one or more of the workpieces may affect service life of the weld joint, and hence may affect service life of the component that includes the weld joint. When the workpiece stack includes a plurality of battery cell foils that are welded to a battery tab, the occurrence of localized material voids may affect electrical conductivity between one or more of the battery cell foils and the battery tab. The concepts described herein, including the arrangements of the workpiece stacks and the associated laser welding processes reduce occurrences of localized material voids and/or gaps, thus reducing part-to-part variability, achieving design-intent electrical conductivity levels, and improving service life.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

What is claimed is:

1. A method for joining, via a laser welder, a plurality of battery cell foils to a battery tab, wherein each of the battery cell foils is configured as a sheet including a first edge, and wherein the battery tab is configured as a sheet including a second edge, a first surface, and a second surface that is opposed to the first surface, the method comprising:
arranging the plurality of battery cell foils in a stack, wherein the first edges of the battery cell foils are disposed in parallel;
positioning the battery cell foils arranged in the stack such that the first edges of the battery cell foils underlap a portion of the battery tab and are adjacent to the first surface of the battery tab; and
executing, via the laser welder, a welding operation to form a weld joint joining the battery cell foils and the battery tab;
wherein the welding operation includes directing a laser beam to the second surface of the battery tab to form a weld joint; and
wherein the weld joint is within 1.5 mm of the first edges of the battery cell foils.

2. The method of claim 1, wherein the first edges of the battery cell foils being disposed in parallel comprises the first edges being arranged in parallel and defining a second plane that is orthogonal to a first plane that is defined by the stacked battery cell foils.

3. The method of claim 1, wherein the first edges of the battery cell foils being disposed in parallel comprises the first edges being arranged in parallel and defining a second plane that is tapered relative to a first plane that is defined by the stacked battery cell foils.

4. The method of claim 3, wherein the plurality of cell foils includes a bottom cell foil that is disposed most distant from the battery tab, and wherein the welding operation is executed within 1.5 mm of the first edge of the bottom cell foil.

5. The method of claim 1, further comprising applying a compressive load to the plurality of battery cell foils and the battery tab, wherein applying the compressive load to the plurality of battery cell foils and the battery tab includes excluding a portion of the battery cell foils that underlaps the portion of the battery tab.

6. The method of claim 1, wherein positioning the battery cell foils arranged in the stack such that the first edges of the battery cell foils underlap a portion of the battery tab comprises positioning the battery tab overtop of the battery cell foils and overlapping the portion of the battery cell foils.

7. The method of claim 6, comprising positioning the battery tab overtop of the battery cell foils to overlap the portion of the battery cell foils by a width that is less than 1.8 mm.

8. The method of claim 1, wherein the second surface of the battery tab comprises a top surface that is proximal to the laser welder, and wherein executing, via the laser welder, a welding operation to form a weld joint joining the battery cell foils and the battery tab comprises generating, via the laser welder, a laser beam that is directed onto the top surface of the battery tab.

9. The method of claim 8, wherein generating, via the laser welder, the first laser beam comprises controlling the laser beam to have a focal point that is disposed beneath the top surface of the first workpiece.

10. An apparatus for joining a plurality of battery cell foils to a battery tab, wherein each of the battery cell foils is configured as a sheet including a first edge, and wherein the battery tab is configured as a sheet including a second edge, the apparatus comprising:
a laser welder; and
a clamping mechanism including an anvil, a first clamping device and a second clamping device;
wherein the battery cell foils are arranged in a stack;
wherein the battery cell foils arranged in the stack are positioned such that the first edges of the battery cell foils are disposed in parallel and underlap a portion of the battery tab;
wherein the clamping mechanism is configured to apply a compressive load to the plurality of battery cell foils and the battery tab;
wherein the laser welder is operable to execute a welding operation to form a weld that joins the battery cell foils and the battery tab;
wherein the welding operation includes directing a laser beam onto the second surface of the battery tab; and
wherein a weld joint formed by the welding operation is disposed within 1.5 mm of the first edges of the battery cell foils.

11. A weld joint, comprising:
a plurality of battery cell foils, wherein each of the battery cell foils is configured as a sheet including a first edge;
a battery tab, wherein the battery tab is configured as a sheet including a first surface, and a second surface that is opposed to the first surface, and a second edge;
wherein the battery cell foils are arranged in a stack,
wherein the first edges of the battery cell foils are disposed in parallel,
wherein the battery cell foils are arranged in the stack such that the first edges of the battery cell foils underlap a portion of the battery tab and are adjacent to the first surface of the battery tab;
wherein the battery cell foils are joined to the battery tab by executing, via the laser welder, a welding operation to form a weld joint joining the battery cell foils and the battery tab;
wherein the welding operation includes directing a laser beam to the second surface of the battery tab to form a weld joint; and
wherein the weld joint is formed within 1.5 mm of the first edges of the battery cell foils.

12. The weld joint of claim 11, wherein the battery tab is fabricated from either copper or aluminum.

13. The weld joint of claim 11, wherein the battery cell foils are fabricated from either copper or aluminum.

14. The weld joint of claim 11, wherein each of battery cell foils has a thickness of 0.02 mm.

15. The weld joint of claim 11, wherein the weld joint is formed as a butt joint when the battery cell foils are arranged in the stack such that the first edges of the battery cell foils underlap a portion of the battery tab by less than 1.8 mm.

16. The weld joint of claim 11, wherein the weld joint comprises a fillet joint.

17. The weld joint of claim 11, wherein the first edges of the battery cell foils being disposed in parallel comprises the first edges being arranged in parallel and defining a second plane that is orthogonal to a first plane that is defined by the stacked battery cell foils.

18. The weld joint of claim 11, wherein the first edges of the battery cell foils being disposed in parallel comprises the first edges being arranged in parallel and defining a second plane that is tapered relative to a first plane that is defined by the stacked battery cell foils.
